(19) United States
(12) Patent Application Publication
(10) Pub. No.: US 2025/0291885 A1
(43) Pub. Date: Sep. 18, 2025

(54) SYSTEMS AND METHODS FOR PROVIDING MULTIFACTOR AUTHENTICATION FOR IMMERSIVE ENVIRONMENTS

(71) Applicant: Verizon Patent and Licensing Inc., Basking Ridge, NJ (US)

(72) Inventors: Ravi Kiran TUMMALA, Hyderabad (IN); Lokesh KOSURI, Hyderabad (IN)

(73) Assignee: Verizon Patent and Licensing Inc., Basking Ridge, NJ (US)

(21) Appl. No.: 18/602,291

(22) Filed: Mar. 12, 2024

(51) Int. Cl. G06F 21/32; G06F 21/40

(52) U.S. Cl. CPC G06F 21/32; G06F 21/40

(57) ABSTRACT

A device may receive, from a user device, a custom pose of a user of an immersive environment, and may generate a pose identifier for the user based on the custom pose. The device may receive, from the user device, a custom signature of the user in a three-dimensional space, and may generate a signature identifier for the user based on the custom signature. The device may authenticate the user to access the immersive environment based on at least the pose identifier.

### BACKGROUND

Immersive environments, such as virtual reality environments, augmented reality environments, and mixed reality environments, have become increasingly prevalent, have been integrated into various aspects of modern life, and have redefined user interaction within digital environments.

### BRIEF DESCRIPTION OF THE DRAWINGS

FIGS. 1A-1E are diagrams of an example associated with providing multifactor authentication for immersive environments.

FIG. 2 is a diagram of an example environment in which systems and/or methods described herein may be implemented.

FIG. 3 is a diagram of example components of one or more devices of FIG. 2.

FIGS. 4 and 5 are flowcharts of example processes for providing multifactor authentication for immersive environments.

### DETAILED DESCRIPTION OF EXAMPLE EMBODIMENTS

The following detailed description of example implementations refers to the accompanying drawings. The same reference numbers in different drawings may identify the same or similar elements.

Immersive environments demand heightened levels of privacy and security due to sensitive natures of transactions and interactions that occur within them. However, current authentication systems in immersive environments lack robust multi-factor authentication methods that are essential for ensuring secure access and for protecting user identity. Traditional authentication systems fail to utilize personal signatures or actions as a means of unique user identification and to provide security features. Consequently, the traditional authentication systems are inadequate for multifactor authentication in immersive environments and are also susceptible to being compromised, which poses significant risks in immersive environments where secure transactions and interactions are paramount.

Thus, current techniques for authenticating a user of an immersive environment may consume computing resources (e.g., processing resources, memory resources, communication resources, and/or the like), networking resources, and/or other resources associated with failing to protect an identity of the user of the immersive environment, failing to enable secure transactions for the user via the immersive environment, failing to enable secure authentication of the user for accessing the immersive environment, handling compromised user information, inadequately identifying and preventing threats to the user, requiring repeated authentication attempts for the user, and/or the like.

Some implementations described herein provide a device (e.g., an authentication system) that provides multifactor authentication for immersive environments. For example, the authentication system may receive, from a user device, a custom pose of a user of an immersive environment, and may generate a pose identifier for the user based on the custom pose. The authentication system may receive, from the user device, a custom signature of the user in a three-dimensional space, and may generate a signature identifier for the user based on the custom signature. The authentication system may authenticate the user to access the immersive environment based on at least the pose identifier.

In this way, the authentication system provides multifactor authentication for immersive environments. For example, the authentication system may provide secure multi-factor authentication for immersive environments, such as virtual reality environments, augmented reality environments, and mixed reality environments. The authentication system may capture a unique pose or gesture of a user of an immersive environment, and may generate a pose identifier for the user. The authentication system may record a depth, a stroke, and a flow of a signature of the user in a three-dimensional space, and may generate a signature identifier for the user. The authentication system may authenticate the user for accessing the immersive environment based on at least the pose identifier, which may provide secure access to functions of the immersive environment. The authentication system may authenticate user actions within the immersive environment (e.g., performance of transactions, signing of agreements, and/or the like) based on the pose identifier and the signature identifier. Thus, the authentication system may conserve computing resources, networking resources, and/or other resources that would have otherwise been consumed by failing to protect an identity of the user of the immersive environment, failing to enable secure transactions for the user via the immersive environment, failing to enable secure authentication of the user for accessing the immersive environment, handling compromised user information, inadequately identifying and preventing threats to the user, requiring repeated authentication attempts for the user, and/or the like.

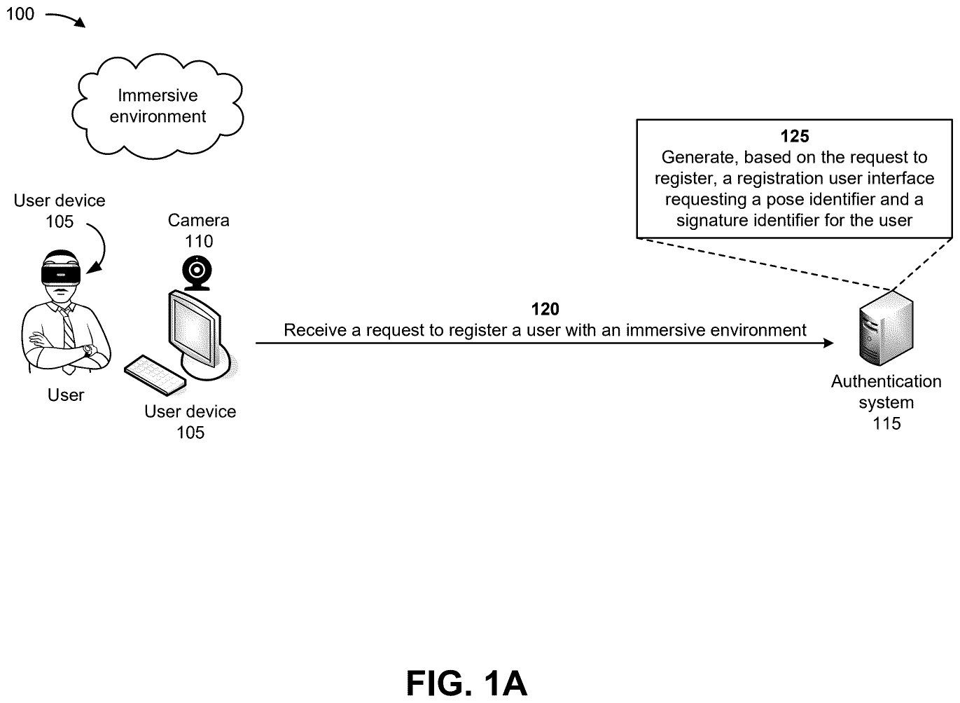

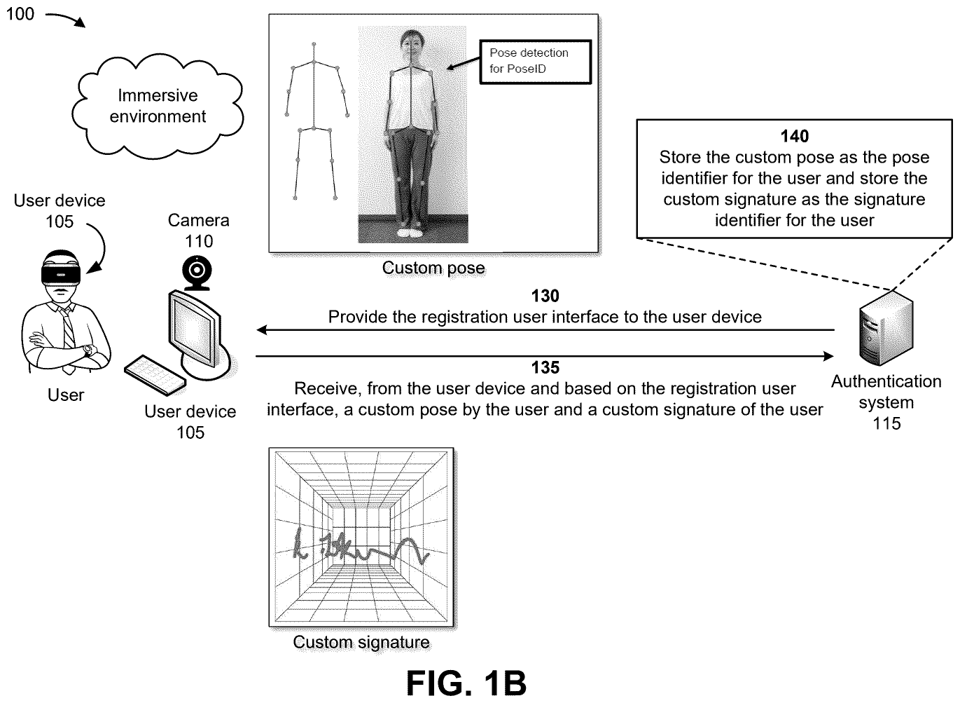

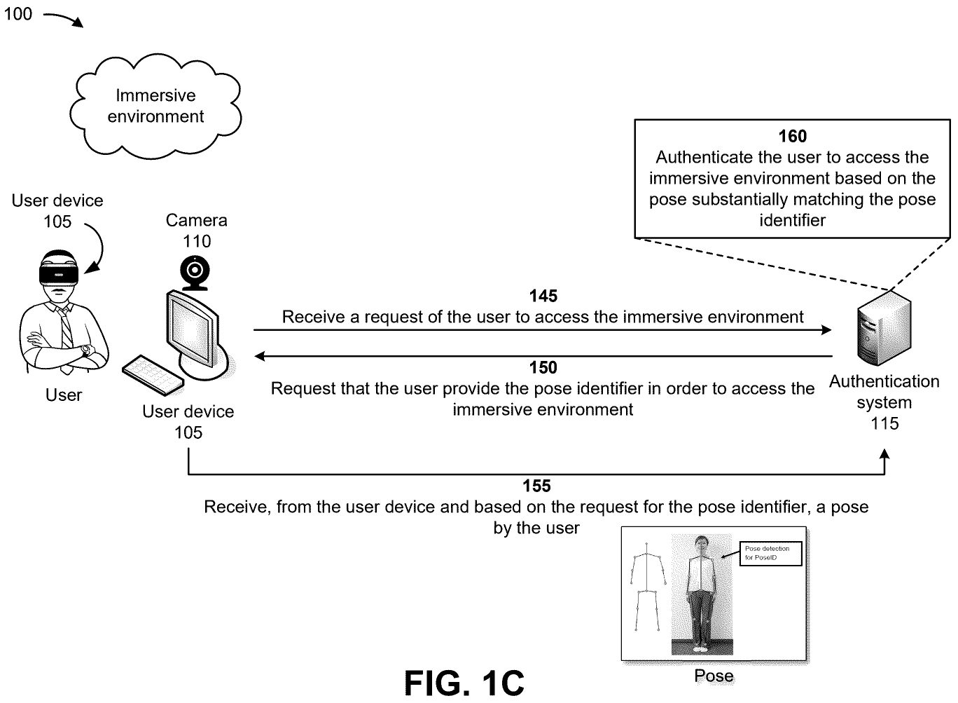

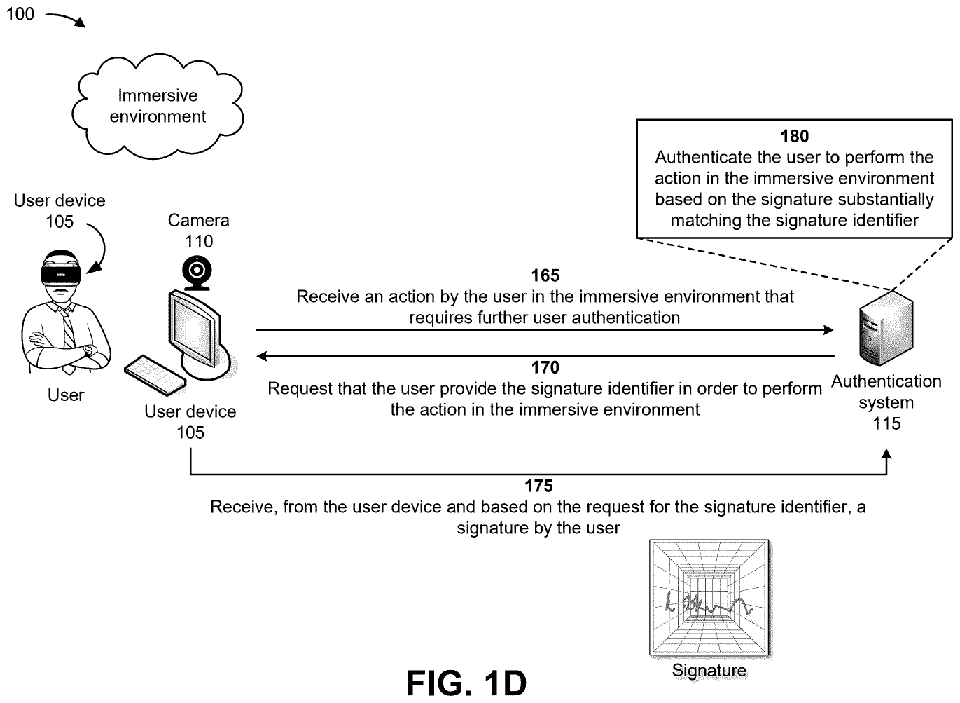

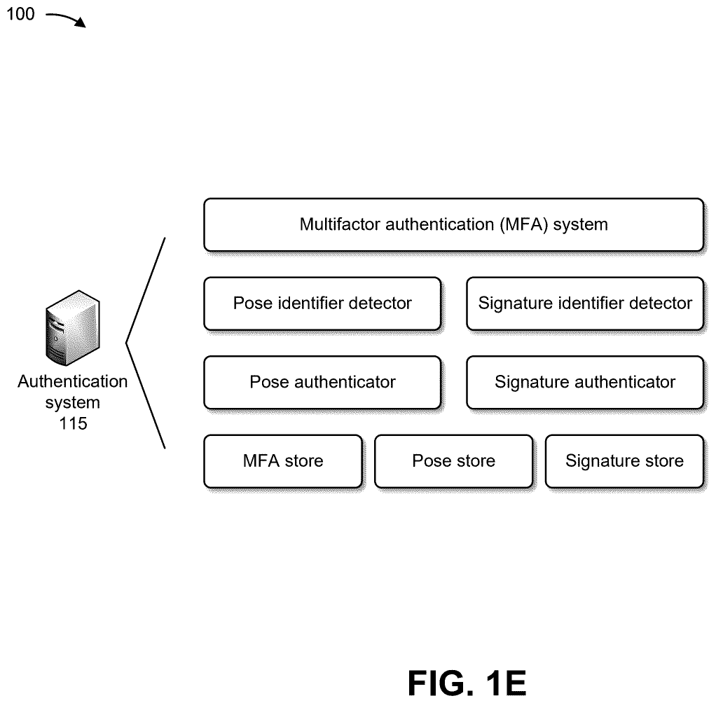

FIGS. 1A-1E are diagrams of an example 100 associated with providing multifactor authentication for immersive environments. As shown in FIGS. 1A-1E, example 100 includes a user device 105 (e.g., associated with a user), a camera 110, an authentication system 115, and an immersive environment. In some implementations, the camera 110 may be included in the user device 105, separate from the user device 105, and/or the like. In some implementations, the user device 105 may include a headset for use in a virtual reality environment, an augmented reality environment, and/or a mixed reality environment. The immersive environment may include a virtual reality environment, an augmented reality environment, or a mixed reality environment. Further details of the user device 105, the camera 110, the authentication system 115, and the immersive environment are provided elsewhere herein. In some implementations, one or more of the functions described herein as being performed by the authentication system 115 may be performed by the user device 105.

As shown in FIG. 1A, and by reference number 120, the authentication system 115 may receive a request to register a user with an immersive environment. For example, the user may not be registered with the immersive environment and the authentication system 115, and may utilize the user device 105 to generate the request to register with the immersive environment and the authentication system 115. The user may cause the user device 105 provide the request to register the user to the authentication system 115, and the authentication system 115 may receive the request to register the user. In some implementations, the authentication system 115 may determine whether the user is registered with the immersive environment by comparing prior user registrations with credentials of the user. If the user is already registered with the immersive environment, the authentication system 115 may provide, to the user device 105, a message indicating that the user is already registered with the immersive environment and requesting that the user utilize the user's credentials (e.g., a username, a password, a pose identifier, a signature identifier, and/or the like) to access the immersive environment. Alternatively, the authentication system 115 may determine that the user is not registered with the immersive environment when the user credentials fail to match the prior user registrations.

As further shown in FIG. 1A, and by reference number 125, the authentication system 115 may generate, based on the request to register, a registration user interface requesting a pose identifier and a signature identifier for the user. For example, when the user is not registered with the immersive environment, the authentication system 115 may generate, based on the request to register, the registration user interface. The registration user interface may include information requesting credentials of the user, such as a name of the user, an organization of the user, an address of the user, a username, a password, and/or the like. The registration user interface may also include information requesting the user to provide a pose identifier and a signature identifier for the user. The pose identifier may be utilized by the authentication system 115 to authenticate the user to access to the immersive environment, and the signature identifier may be utilized by the authentication system 115 to authenticate the user to perform an action associated with the immersive environment (e.g., sign a contract, perform a transaction, and/or the like).

As shown in FIG. 1B, and by reference number 130, the authentication system 115 may provide the registration user interface to the user device 105. For example, the authentication system 115 may provide the registration user interface to the user device 105, and the user device 105 may receive the registration user interface. The user device 105 may display the registration user interface to the user. The registration user interface may instruct the user to provide a custom pose for a time period (e.g., five seconds, ten seconds, and/or the like) and the user device 105 may capture the custom pose (e.g., multiple images) of the user. The registration user interface may also instruct the user to provide a custom signature in a three-dimensional space and the user device 105 may capture the custom signature of the user. In some implementations, the user device 105 may include a sensor (e.g., a LiDAR sensor) that measures an intensity of gestures of the user when the custom signature is generated by the user.

As shown in FIG. 1B, and by reference number 135, the authentication system 115 may receive, from the user device 105 and based on the registration user interface, a custom pose by the user and a custom signature of the user. For example, after capturing the custom pose by the user and the custom signature of the user via the registration user interface, the user device 105 may provide the custom pose and the custom signature to the authentication system 115. The authentication system 115 may receive the custom pose and the custom signature from the user device 105. In some implementations, the authentication system 115 may store the custom pose, the custom signature, and the credentials of the user in a data structure (e.g., a database, a table, a list, and/or the like) associated with the authentication system 115.

As further shown in FIG. 1B, and by reference number 140, the authentication system 115 may store the custom pose as the pose identifier for the user and may store the custom signature as the signature identifier for the user. For example, there are multiple different body points or joints that can collectively form a pose (e.g., eyes, ears, nose, shoulders, hips, elbows, knees, wrists, ankles, and/or the like). The authentication system 115 may analyze the custom pose, may identify the most prominent body joints in a single image of the custom pose, and may utilize the joints to construct a single pose called the pose identifier. The authentication system 115 may utilize the multiple images of the custom pose and may combine the images together in a time period to form the pose identifier.

Every person has a unique way of making strokes when generating a signature. The user device 105 may track the hand movements of the user when providing the custom signature and may utilize a LiDAR sensor to determine a depth or an intensity with which the user makes the hand movements. The authentication system 115 may utilize the tracked hand movements to generate two-dimensional matrix, and may add another dimension (e.g., provided by the depth or the intensity) to generate a three-dimensional matrix that forms the signature identifier. In some implementations, the authentication system 115 may store the pose identifier, the signature identifier, and the credentials of the user in the data structure associated with the authentication system 115.

As shown in FIG. 1C, and by reference number 145, the authentication system 115 may receive a request of the user to access the immersive environment. For example, after the user has already registered with the immersive environment and the authentication system 115 (e.g., via the pose identifier and the signature identifier), the user may cause the user device 105 to generate a request of the user to access the immersive environment. The user may cause the user device 105 to provide the request of the user to access the immersive environment to the authentication system 115, and the authentication system 115 may receive the request of the user to access the immersive environment from the user device 105.

As further shown in FIG. 1C, and by reference number 150, the authentication system 115 may request that the user provide the pose identifier in order to access the immersive environment. For example, when the authentication system 115 receives the request of the user to access the immersive environment, the authentication system 115 may generate a request for the user to provide the pose identifier in order to access the immersive environment. The pose identifier may enable the authentication system 115 to verify that the user is registered to access the immersive environment. The authentication system 115 may provide the request for the user to provide the pose identifier to the user device 105, and the user device 105 may provide the request for the user to provide the pose identifier for display to the user.

As further shown in FIG. 1C, and by reference number 155, the authentication system 115 may receive, from the user device 105 and based on the request for the pose identifier, a pose of the user captured by user device 105 and/or camera 110. For example, based on request for the user to provide the pose identifier, the user may utilize the user device 105 to capture a pose by the user. In some implementations, the user may cause the user device 105 to capture a pose that matches or substantially matches the pose identifier. Alternatively, the user may cause the user device 105 to capture a pose that fails to match the pose identifier. The user may cause the user device 105 to provide the pose by the user to the authentication system 115, and the authentication system 115 may receive the pose by the user from the user device 105.

As further shown in FIG. 1C, and by reference number 160, the authentication system 115 may authenticate the user to access the immersive environment based on the pose substantially matching the pose identifier. For example, the authentication system 115 may compare the pose of the user with the pose identifier to determine whether the pose of the user matches or substantially matches the pose identifier. In some implementations, the authentication system 115 may authenticate the user to access the immersive environment based on the pose matching or substantially matching the pose identifier (e.g., being similar within a predetermined degree of certainty, such as 90%, 95%, etc.). Alternatively, the authentication system 115 may not authenticate the user to access the immersive environment based on the pose failing to match the pose identifier.

In some implementations, the authentication system 115 may utilize a pose detection model to analyze the pose and to validate the pose against the registered pose identifier. The authentication system 115 may validate poses captured in multiple image frames and attempt to match the poses with the pose identifier. In some implementations, the authentication system 115 may store changes or transitions between the multiple frames to determine whether the user is transitioning to a different pose. In some implementations, the user device 105 and/or the authentication system 115 may utilize a pose authentication model that creates a comprehensive and highly accurate representation of user movements and posture. The pose authentication model may continuously or periodically compare a real-time pose of the user with the registered pose identifier to ensure that the user remains authenticated throughout access to the immersive environment. In some implementations, the authentication system 115 may monitor user movements in real time to provide dynamic pose verification and enable continuous authentication even as the user moves, gestures, or performs actions within the immersive environment.

In some implementations, the authentication system 115 may enhance security by ensuring that only authorized users can access the immersive environment, since unauthorized users cannot accurately replicate the registered pose identifier. In some implementations, the authentication system 115 may be utilized with other applications, such as gaming applications, fitness applications, remote collaboration applications, training simulation applications, security-sensitive applications, and/or the like.

As shown in FIG. 1D, and by reference number 165, the authentication system 115 may receive an action by the user in the immersive environment that requires further user authentication. For example, after the user has already registered with the immersive environment and the authentication system 115 (e.g., via the pose identifier and the signature identifier) and has accessed the immersive environment, the user may perform an action in the immersive environment that requires further user authentication. The action may include the user initiating a transaction within the immersive environment (e.g., purchasing a feature, an application, a product, a service, and/or the like), the user executing an agreement within the immersive environment, the user receiving additional features of the immersive environment, and/or the like. The user device 105 may provide the action to the authentication system 115, and the authentication system 115 may receive the action by the user in the immersive environment that requires further user authentication from the user device 105.

As further shown in FIG. 1D, and by reference number 170, the authentication system 115 may request that the user provide the signature identifier in order to perform the action in the immersive environment. For example, when the authentication system 115 receives the action by the user in the immersive environment, the authentication system 115 may generate a request for the user to provide the signature identifier in order to perform the action in the immersive environment. The signature identifier may enable the authentication system 115 to verify that the user is registered to perform the action in the immersive environment. The authentication system 115 may provide the request for the user to provide the signature identifier to the user device 105, and the user device 105 may provide the request for the user to provide the signature identifier for display to the user. In some implementations, the request for the user to provide the signature identifier may include an authentication user interface that includes a section for the user to provide the signature identifier.

As further shown in FIG. 1D, and by reference number 175, the authentication system 115 may receive, from the user device 105 and based on the request for the signature identifier, a signature by the user. For example, based on the request for the user to provide the signature identifier, the user may utilize the user device 105 to capture a signature by the user. In some implementations, the user may cause the user device 105 to capture a signature that matches or substantially matches the signature identifier. Alternatively, the user may cause the user device 105 to capture a signature that fails to match the signature identifier. The user may cause the user device 105 to provide the signature by the user to the authentication system 115, and the authentication system 115 may receive the signature by the user from the user device 105.

As further shown in FIG. 1D, and by reference number 180, the authentication system 115 may authenticate the user to perform the action in the immersive environment based on the signature substantially matching the signature identifier. For example, the authentication system 115 may compare the signature of the user with the signature identifier to determine whether the signature of the user matches or substantially matches the signature identifier. In some implementations, the authentication system 115 may authenticate the user to perform the action in the immersive environment based on the signature matching or substantially matching the signature identifier. Alternatively, the authentication system 115 may not authenticate the user to perform the action in the immersive environment based on the signature failing to match the signature identifier.

In some implementations, the authentication system 115 may utilize a model that receives the signature as an input and compares the signature with the registered signature identifier. A sensitivity of the model may be adjusted based on success or failure rates associated with received signatures. For example, a sensitivity of 0.8 may be comparatively strict. In some implementations, the model may be more biased toward signature depth as each user may utilize a particular intensity while making signature strokes, and may validate a signature using six degrees of view and comparison.

FIG. 1E depicts example components of the authentication system 115. As shown, the authentication system 115 may include a multifactor authentication (MFA) system, a pose identifier detector, a signature identifier detector, a pose authenticator, a signature authenticator, an MFA store, a pose store, and a signature store.

The MFA system may include a system that performs one or more of the functions described above in connection with the authentication system 115. The pose identifier detector may identify the most prominent joints in an image frame of a pose, and may utilize the joints to construct a single pose. The pose identifier detector may combine multiple poses together in a time frame to form the pose identifier. The signature identifier detector may track hand movements of a user during a signature and may utilize a LiDAR sensor to determine a depth or an intensity with which the user makes hand movements. With the tracked hand movements forming a two-dimensional matrix, the signature identifier detector may add one more dimension (e.g., the depth of the signature) to form a three-dimensional matrix for the signature identifier.

The pose authenticator may utilize the pose detection model to identify the user pose and to validate the pose against the registered pose identifier. The pose authenticator may validate each of the poses of multiple image frames and may match the poses with the pose identifier. The signature authenticator may include the model that receives the signature as input and compares the signature with the signature identifier. The MFA store may include a data structure that stores data associated with users registered with the immersive environment and/or the authentication system 115. The pose store may include a data structure that stores pose identifiers associated with users registered with the immersive environment and/or the authentication system 115. The signature store may include a data structure that stores signature identifiers associated with users registered with the immersive environment and/or the authentication system 115.

In some implementations, the authentication system 115 may authenticate users of immersive environments. The authentication system 115 may be utilized in immersive environments for payments and contract signing purposes, to provide a safe and secure immersive authentication between a user and a seller. The authentication system 115 may ensure that users may easily sign contracts and documents in a secure way, may reduce fraud, and may increase security for transactions.

In this way, the authentication system 115 provides multifactor authentication for immersive environments. For example, the authentication system 115 may provide secure multi-factor authentication for immersive environments, such as virtual reality environments, augmented reality environments, and mixed reality environments. The authentication system 115 capture a unique pose or gesture of a user of an immersive environment, and may generate a pose identifier for the user. The authentication system 115 may record a depth, a stroke, and a flow of a signature of the user in a three-dimensional space, and may generate a signature identifier for the user. The authentication system 115 may authenticate the user for accessing the immersive environment based on at least the pose identifier, which may provide secure access to functions of the immersive environment. The authentication system 115 may authenticate user actions within the immersive environment based on the pose identifier and the signature identifier. Thus, the authentication system 115 may conserve computing resources, networking resources, and/or other resources that would have otherwise been consumed by failing to protect an identity of the user of the immersive environment, failing to enable secure transactions for the user via the immersive environment, failing to enable secure authentication of the user for accessing the immersive environment, handling compromised user information, inadequately identifying and preventing threats to the user, requiring repeated authentication attempts for the user, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

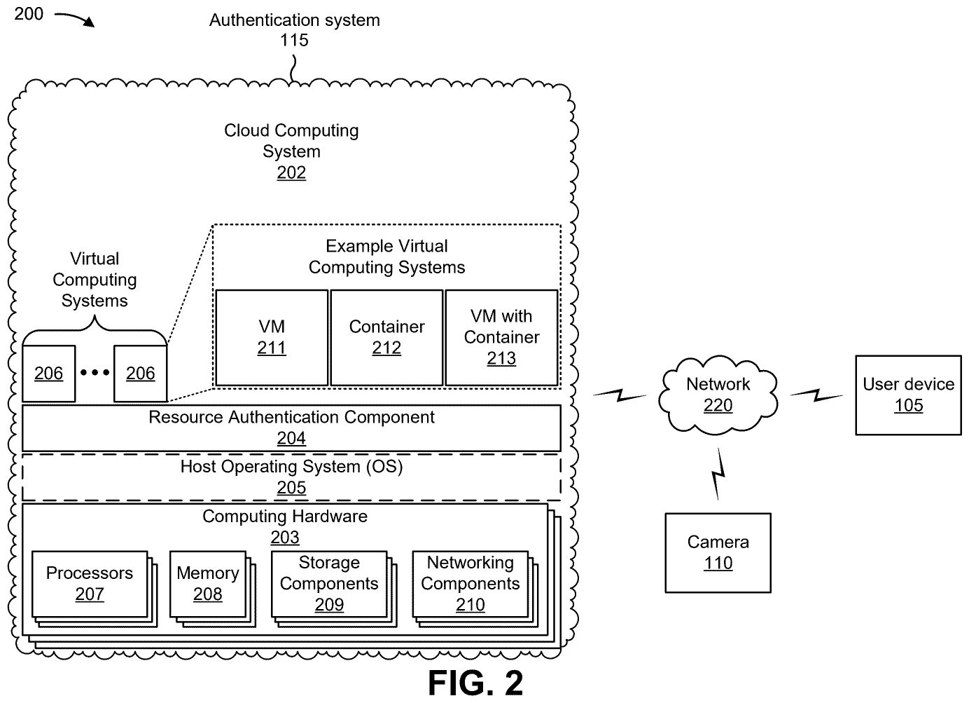

FIG. 2 is a diagram of an example environment 200 in which systems and/or methods described herein may be implemented. As shown in FIG. 2, the environment 200 may include the authentication system 115, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a virtual assistant device, or a similar type of device.

The camera 110 may include one or more devices capable of receiving, generating, storing, processing, providing, and/or routing information, as described elsewhere herein. The camera 110 may include a communication device and/or a computing device. For example, the camera 110 may include an optical instrument that captures images, audio, and/or videos (e.g., images and audio). The camera 110 may feed real-time images and/or video directly to the user device 105 or the display of the user device 105, may record captured images and/or video to a storage device for archiving or further processing, and/or the like.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

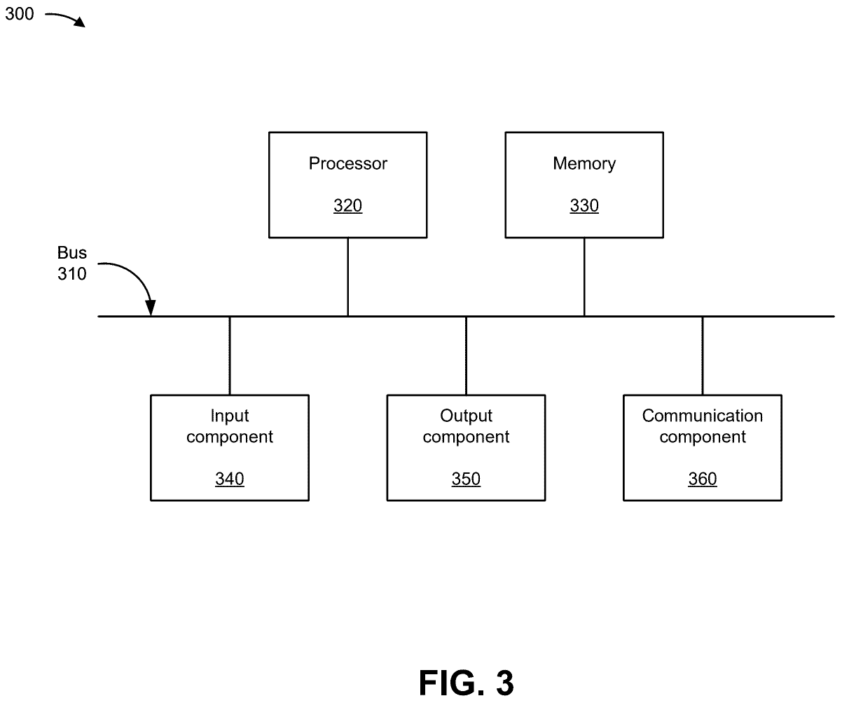

Although the authentication system 115 may include one or more elements 203-213 of the cloud computing system 202, may execute within the cloud computing system 202, and/or may be hosted within the cloud computing system 202, in some implementations, the authentication system 115 may not be cloud-based (e.g., may be implemented outside of a cloud computing system) or may be partially cloud-based. For example, the authentication system 115 may include one or more devices that are not part of the cloud computing system 202, such as the device 300 of FIG. 3, which may include a standalone server or another type of computing device. The authentication system 115 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the camera 110, and/or the authentication system 115. In some implementations, the user device 105, the camera 110, and/or the authentication system 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

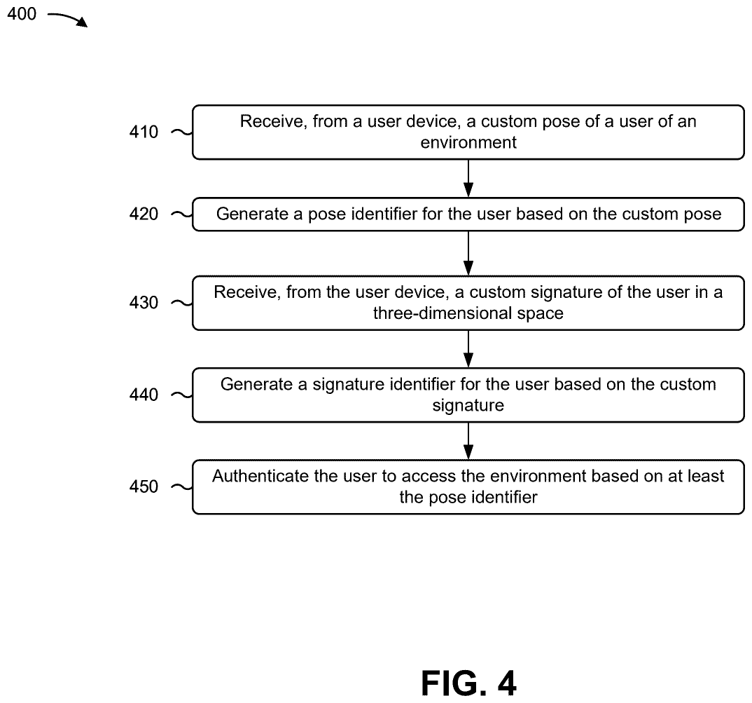

FIG. 4 is a flowchart of an example process 400 for providing multifactor authentication for immersive environments. In some implementations, one or more process blocks of FIG. 4 may be performed by a device (e.g., the authentication system 115). In some implementations, one or more process blocks of FIG. 4 may be performed by another device or a group of devices separate from or including the device, such as a user device (e.g., the user device 105) and/or a camera (e.g., the camera 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a user device, a custom pose of a user of an environment (block 410). For example, the device may receive, from a user device, a custom pose of a user of an environment, as described above. In some implementations, the custom pose of the user is captured by the user device over a time period. In some implementations, the environment includes one of a virtual reality environment, an augmented reality environment, or a mixed reality environment.

As further shown in FIG. 4, process 400 may include generating a pose identifier for the user based on the custom pose (block 420). For example, the device may generate a pose identifier for the user based on the custom pose, as described above.

As further shown in FIG. 4, process 400 may include receiving, from the user device, a custom signature of the user in a three-dimensional space (block 430). For example, the device may receive, from the user device, a custom signature of the user in a three-dimensional space, as described above. In some implementations, the custom signature is enhanced by a sensor that measures an intensity of gestures of the user when the custom signature is generated.

As further shown in FIG. 4, process 400 may include generating a signature identifier for the user based on the custom signature (block 440). For example, the device may generate a signature identifier for the user based on the custom signature, as described above.

As further shown in FIG. 4, process 400 may include authenticating the user to access the environment based on at least the pose identifier (block 450). For example, the device may authenticate the user to access the environment based on at least the pose identifier, as described above. In some implementations, authenticating the user to access the environment based on at least the pose identifier includes prompting the user to perform a pose during a login process to the environment, and authenticating the user to access the environment based on the pose substantially matching the pose identifier. In some implementations, authenticating the user to access the environment based on at least the pose identifier includes utilizing a pose detection model to analyze and validate a pose of the user compared to the pose identifier.

In some implementations, process 400 includes authenticating the user to perform an action in the environment based at least on the signature identifier. In some implementations, process 400 includes providing the three-dimensional space for display to the user device, wherein the user provides the custom signature to the user device via the three-dimensional space. In some implementations, process 400 includes authenticating the user to initiate a transaction within the environment based on the signature identifier. In some implementations, process 400 includes storing the pose identifier and the signature identifier in a data structure.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

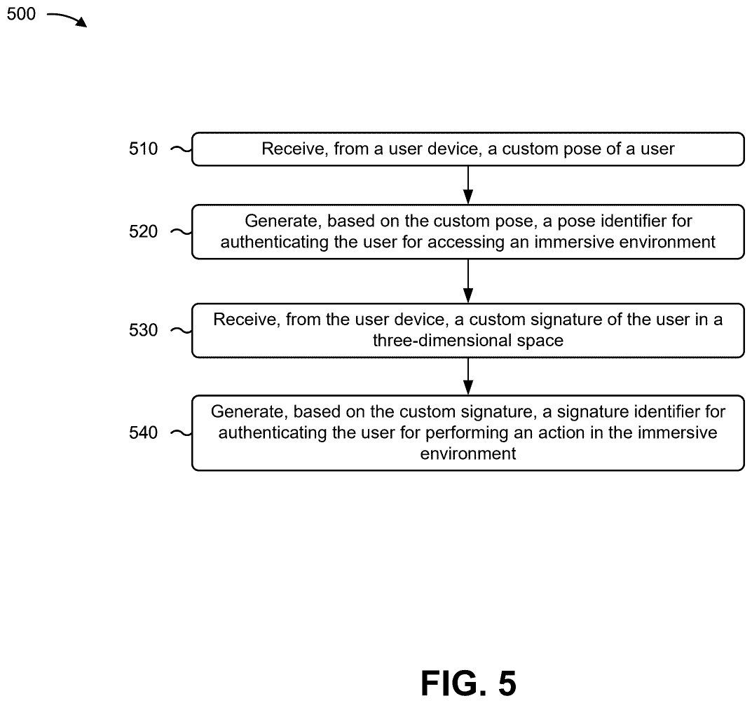

FIG. 5 is a flowchart of an example process 500 for providing multifactor authentication for immersive environments. In some implementations, one or more process blocks of FIG. 5 may be performed by a device (e.g., the authentication system 115). In some implementations, one or more process blocks of FIG. 5 may be performed by another device or a group of devices separate from or including the device, such as a user device (e.g., the user device 105) and/or a camera (e.g., the camera 110). Additionally, or alternatively, one or more process blocks of FIG. 5 may be performed by one or more components of the device 300, such as the processor 320, the memory 330, the input component 340, the output component 350, and/or the communication component 360.

As shown in FIG. 5, process 500 may include receiving, from a user device, a custom pose of a user (block 510). For example, the device may receive, from a user device, a custom pose of a user, as described above. In some implementations, the pose identifier includes a sequence of poses of the user within a predetermined time frame.

As further shown in FIG. 5, process 500 may include generating, based on the custom pose, a pose identifier for authenticating the user for accessing an immersive environment (block 520). For example, the device may generate, based on the custom pose, a pose identifier for authenticating the user for accessing an immersive environment, as described above.

As further shown in FIG. 5, process 500 may include receiving, from the user device, a custom signature of the user in a three-dimensional space (block 530). For example, the device may receive, from the user device, a custom signature of the user in a three-dimensional space, as described above.

As further shown in FIG. 5, process 500 may include generating, based on the custom signature, a signature identifier for authenticating the user for performing an action in the immersive environment (block 540). For example, the device may generate, based on the custom signature, a signature identifier for authenticating the user for performing an action in the immersive environment, as described above. In some implementations, the signature identifier includes a three-dimensional matrix generated based on hand movement tracking and depth sensing. In some implementations, the action includes initiating a transaction within the immersive environment. In some implementations, the action includes enabling execution of an agreement within the immersive environment.

In some implementations, process 500 includes prompting the user to perform a pose during a login process to the immersive environment, and authenticating the user to access the immersive environment based on the pose substantially matching the pose identifier. In some implementations, process 500 includes prompting the user to provide a signature for performing the action in the immersive environment, and authenticating the user to perform the action in the immersive environment based on the signature substantially matching the signature identifier.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and from a user device, a custom pose of a user of an environment;
generating, by the device, a pose identifier for the user based on the custom pose;
receiving, by the device and from the user device, a custom signature of the user in a three-dimensional space;
generating, by the device, a signature identifier for the user based on the custom signature; and
authenticating, by the device, the user to access the environment based on at least the pose identifier.

2. The method of claim 1, further comprising:
authenticating the user to perform an action in the environment based at least on the signature identifier.

3. The method of claim 1, wherein authenticating the user to access the environment based on at least the pose identifier comprises:
prompting the user to perform a pose during a login process to the environment; and
authenticating the user to access the environment based on the pose substantially matching the pose identifier.

4. The method of claim 1, further comprising:
providing the three-dimensional space for display to the user device,
wherein the user provides the custom signature to the user device via the three-dimensional space.

5. The method of claim 1, wherein the custom signature is enhanced by a sensor that measures an intensity of gestures of the user when the custom signature is generated.

6. The method of claim 1, wherein the custom pose of the user is captured by the user device over a time period.

7. The method of claim 1, wherein authenticating the user to access the environment based on at least the pose identifier comprises:
utilizing a pose detection model to analyze and validate a pose of the user compared to the pose identifier.

8. A device, comprising:
one or more processors configured to:
receive, from a user device, a custom pose of a user;
generate, based on the custom pose, a pose identifier for authenticating the user for accessing an immersive environment;
receive, from the user device, a custom signature of the user in a three-dimensional space; and
generate, based on the custom signature, a signature identifier for authenticating the user for performing an action in the immersive environment.

9. The device of claim 8, wherein the pose identifier includes a sequence of poses of the user within a predetermined time frame.

10. The device of claim 8, wherein the signature identifier includes a three-dimensional matrix generated based on hand movement tracking and depth sensing.

11. The device of claim 8, wherein the one or more processors are further configured to:
prompt the user to perform a pose during a login process to the immersive environment; and
authenticate the user to access the immersive environment based on the pose substantially matching the pose identifier.

12. The device of claim 8, wherein the one or more processors are further configured to:
prompt the user to provide a signature for performing the action in the immersive environment; and
authenticate the user to perform the action in the immersive environment based on the signature substantially matching the signature identifier.

13. The device of claim 8, wherein the action includes initiating a transaction within the immersive environment.

14. The device of claim 8, wherein the action includes enabling execution of an agreement within the immersive environment.

15. A non-transitory computer-readable medium storing a set of instructions, the set of instructions comprising:
one or more instructions that, when executed by one or more processors of a device, cause the device to:
provide, to a user device associated with a user of an immersive environment, a user interface requesting that the user provide a custom pose and a custom signature;
receive, via the user interface, the custom pose of the user;
generate a pose identifier for the user based on the custom pose;
receive, via the user interface, the custom signature of the user in a three-dimensional space;
generate a signature identifier for the user based on the custom signature; and
authenticate the user to access the immersive environment based on at least the pose identifier.

16. The non-transitory computer-readable medium of claim 15, wherein the one or more instructions further cause the device to:
authenticate the user to initiate a transaction within the immersive environment based on the signature identifier.

17. The non-transitory computer-readable medium of claim 15, wherein the one or more instructions further cause the device to:
prompt the user to provide a signature for executing an agreement in the immersive environment; and
authenticate the agreement based on the signature substantially matching the signature identifier.

18. The non-transitory computer-readable medium of claim 15, wherein the one or more instructions further cause the device to:
store the pose identifier and the signature identifier in a data structure.

19. The non-transitory computer-readable medium of claim 15, wherein the one or more instructions, that cause the device to authenticate the user to access the immersive environment based on at least the pose identifier, cause the device to:
utilize a pose detection model to analyze and validate a pose of the user compared to the pose identifier.

20. The non-transitory computer-readable medium of claim 15, wherein the immersive environment includes one of a virtual reality environment, an augmented reality environment, or a mixed reality environment.
